(19) United States
(12) Patent Application Publication
(10) Pub. No.: US 2005/0261952 A1
(43) Pub. Date: Nov. 24, 2005

(54) Computer-implemented method and system for modeling and estimating vehicle sales

(75) Inventors: Gintaras Puskorius, Novi, MI (US); Scott Sandler, West Bloomfield, MI (US); Chris Posey, Highlands Ranch, CO (US); Anthony Volpe, West Roxbury, MA (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/852,257

(22) Filed: May 24, 2004

(51) Int. Cl. G06F 17/60

(52) U.S. Cl. 705/10

(57) ABSTRACT

Data representing known vehicle sales and data representing vehicle registrations corresponding to the known vehicle sales are received at a computing system and processed to create a model of vehicle sales as a function of vehicle registrations. The model is applied to vehicle registration data for vehicles having unknown or unavailable sales data to compute a sales estimate for those vehicles having unknown or unavailable sales information. An adaptive filter may be implemented to adapt the model to create an estimate of vehicle sales for vehicles having no registration information (e.g., for estimating recent vehicle sales). The model may be created on a regional (e.g. state-by-state, country region, sales region, etc.) and/or nameplate (e.g. brand-by-brand) basis. Reports may be generated in a variety of different formats.

### BACKGROUND OF THE INVENTION

1. Field of the Invention

The present invention relates generally to methods and systems for processing and modeling data, and more specifically to a computer-implemented method and system for modeling and estimating vehicle sales.

2. Background Art

Gauging competitor performance in the vehicle manufacturing industry is key to a vehicle manufacturer's revenue management. One way in which competitors' performance can be gauged is by their vehicle sales performance. To be effective, however, competitive vehicle sales must be determined at a useful level of granularity.

Due to the variety (i.e. brand/model complexity) and “regionality” or segmentation of the vehicle industry, periodic total sales data is of little help in understanding competitor performance in the different geographic markets and with respect to the different vehicle models being sold. Indeed, a competitor may be doing very well in one market, and average or below average in another. The same may be true with respect to the different vehicle models and brands the competition may offer. Summary vehicle sales data does not effectively indicate the state of such market complexity.

Although automotive market data providers publish end-of-month OEM-reported national sales, those sales do not include the regional or nameplate detail necessary for effectively gauging competitor performance at a useful level of granularity. Nor do the market data providers publish a retail/fleet sales split. Further, several months of sales may be combined in a reporting period, and weekly detail is typically not provided. Any transaction sampling that may occur is typically random—neither uniform nor comprehensive.

In addition, vehicle sales data is typically not published or otherwise made available until months after the data period has passed. Accordingly, the data is not current, and any manufacturer use of or response to the data is delayed. This challenges a manufacturer's ability to effectively react to or otherwise use competitive sales data in a timely fashion. Currently, detailed sales data is particularly useful for launching and evaluating the impact of contest and incentive programs, launching and evaluating the impact of marketing campaigns, and promptly reacting to market trends.

### SUMMARY OF THE INVENTION

One objective of the present invention is to effectively model vehicle sales based on a correlation between known vehicle registration data and known vehicle sales data.

Another objective of the present invention is to estimate current competitive vehicle sales and resulting market share based on the vehicle sales model. According to one aspect of the present invention, current competitive vehicle sales and market share may be estimated by region or market segment, and by brand or vehicle model. This level of granularity enables entities such as vehicle manufacturers, dealerships, etc. to more effectively tailor their marketing programs, contest/incentive programs, etc. to the current market status in a real-time fashion.

Embodiments of the present invention include a computer-implemented method and computer system for estimating vehicle sales comprising receiving data representing known vehicle sales information into a computing system, receiving data representing vehicle registrations corresponding to the known vehicle sales into the computing system, processing the data representing known vehicle sales information and the data representing vehicle registrations to create a model of vehicle sales as a function of vehicle registrations, and, within the computing system, applying the model to registration data for vehicles having unknown sales information to compute a vehicle sales estimate for vehicles having unknown sales information.

Another aspect of the present invention enables the competition of near real-time competitive vehicle sales based on a set of sampled sales transaction data and the vehicle sales estimate.

Vehicle sales may be estimated at various levels of granularity (e.g., region, segment, brand, model, etc.).

Reports may be generated in a variety of different formats including regional reports by vehicle manufacturer and brand over a period of time, and sub-segment reports.

A system embodiment of the present invention may be implemented on a web-based platform including an intranet or the Internet.

### BRIEF DESCRIPTION OF THE DRAWINGS

FIG. 1 illustrates a preferred methodology for implementing embodiments of the present invention;

FIG. 2 is a block flow diagram illustrating an alternate embodiment of the present invention, or a varying perspective of the embodiment illustrated in FIG. 1;

FIG. 3 is a network architecture diagram illustrating a preferred network architecture for implementing one embodiment of the present invention;

FIG. 4 is an example of graphical user interface (GUI) for querying processed data in accordance with one aspect of the present invention;

FIG. 5 is an example national U.S. retail market share report generated in accordance with one aspect of the present invention;

FIG. 6 is an example estimated U.S. retail market share sub-segment report generated in accordance with one aspect of the present invention; and

FIG. 7 is a chart displaying an example comparison between known vehicle registration data and corresponding sales estimates generated in accordance with embodiments of the present invention.

### DETAILED DESCRIPTION OF THE PREFERRED EMBODIMENTS

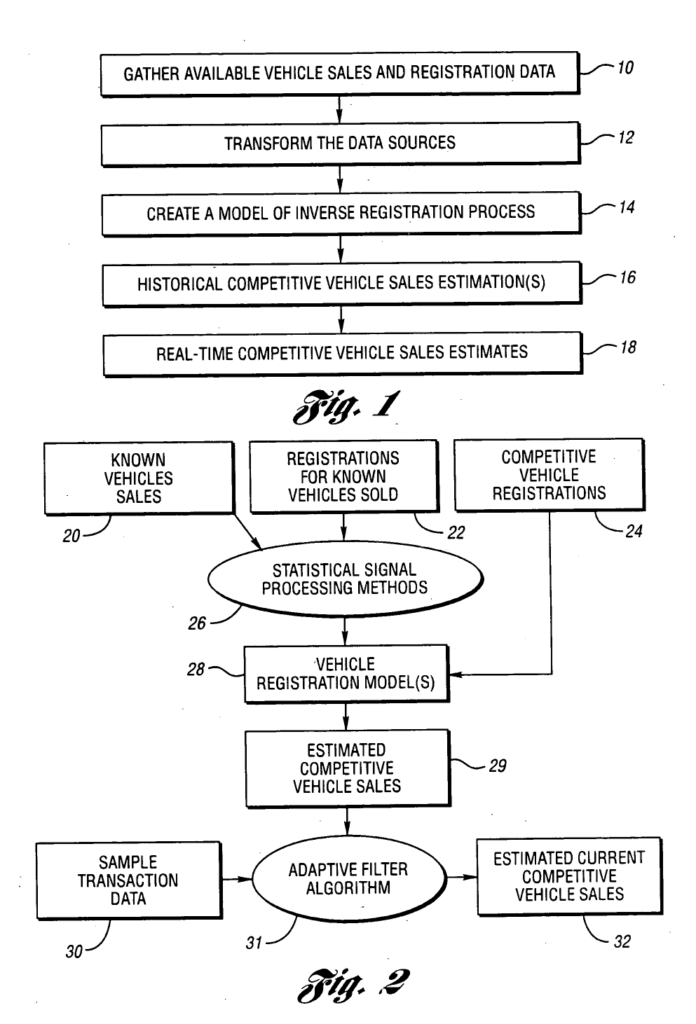

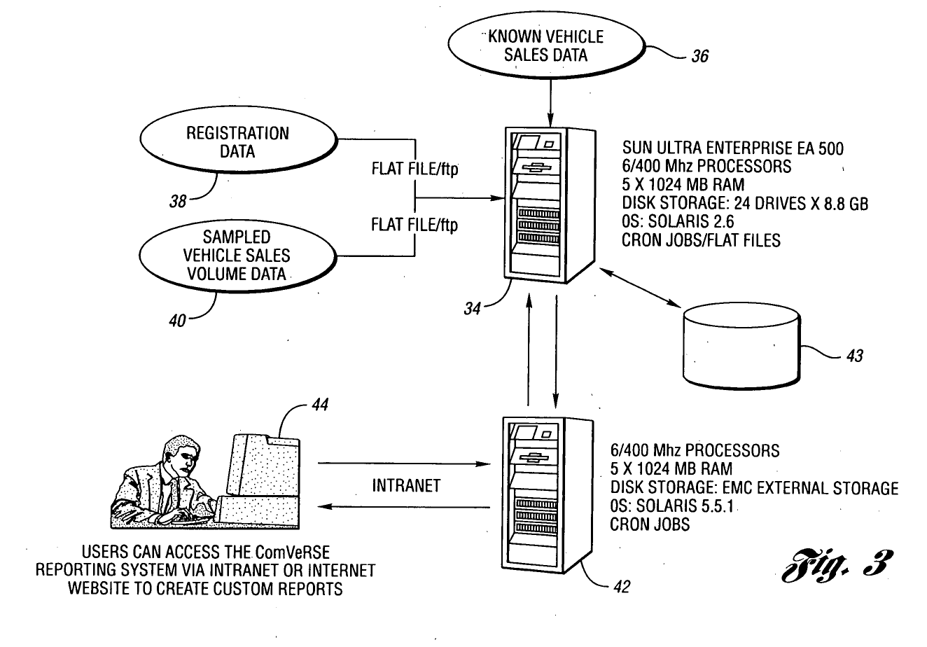

FIG. 1 is a block-flow diagram illustrating an overview of a preferred methodology to implement the present invention. FIG. 2 illustrates the preferred methodology in greater detail. One or more aspects of the methodologies may be implemented programmatically within one or more computers. Notably, the content or arrangement of steps provided in FIGS. 1 and 2 may be adapted, supplemented, or otherwise modified to best fit a particular implementation scenario.

The preferred methodology illustrated in FIG. 1 includes gathering available vehicle sales and registration data from available data sources as represented in block 10, programmatically transforming the gathered data into a common or integrated data set as represented in block 12, generating computer models of one or more inverse registration processes based on the data as represented in block 14, computing historical competitive vehicle sales estimates based on the model as represented in block 16, and computing real-time or current competitive vehicle sales estimates based on the model in conjunction with sample sales transaction data as represented in block 18. These general aspects of the preferred methodology are described in detail under their respective section headings below.

FIG. 2 illustrates aspects of the present invention in greater detail. In accordance with a preferred embodiment of the present invention, four categories of data are received: known vehicle sales data 20, registration data for known sold vehicles 22, competitive vehicle registration data 24, and sampled sales transaction data 30.

Utilizing statistical signal processing methods 26 described in greater detail below, inverse models of the registration process 28 may be programmatically or automatically created. The models may be region or state specific, time-varying, and apply to all brands, models, etc.

Based on the models and collected vehicle registration data, historical competitive vehicle sales estimates may be computed, as represented in block 29.

By comparing the models 28 to samples of current vehicle sales transactions 30, current competitive vehicle sales 32 estimates may be computed as well—without corresponding vehicle registration data for the most recent time periods.

Estimates 29 and 32 may have a variety of valuable uses in the marketplace. For example, estimated competitive vehicle sales 32 may be utilized for contest/incentive post- program analysis, estimating the impact of fixed marketing, developing a market response model, input to C&I, and as an early warning indicator of market trends.

Gather Sales and Registration Data (10)

Preferably known historical vehicle sales data are gathered for vehicles ranging over several years. A separate record may be obtained for each sale. The vehicle body style, model year, dealer region and state, customer region and state, and vehicle selling date may be recorded for each vehicle sale.

New vehicle registration data may be obtained from an automotive market data source. Such sources may provide this data electronically according to a monthly time series format, with unique time series for unique vehicle-model year-state-region combinations. This data conventionally includes registration type (e.g., retail vs. fleet), registration state and region of registration, registration month and year, and the number of vehicles of a given body style (e.g., 4-door Explorer) and model year that were registered in that region-state combination within a given month.

Typically, the automotive market data is published or otherwise made available in a delayed fashion. For example, registration data obtained in early August may consist of registrations recorded in June and earlier.

Competitive new vehicle sales data may be obtained electronically from automotive market data providers as well. This data is typically available week-by-week. However, the data is typically limited and randomly-sampled. The data is not uniformly collected across different vehicle brands and regions. Each data record may correspond to a new vehicle sales transaction, and includes information about the vehicle characteristics, finance characteristics, including transaction price and cost, region of sale, date of sale, etc.

Transform the Data Sources (12)

This step includes programmatically translating vehicle body style descriptions from the different data sources into a common set of definitions. This step may be accomplished via the use of translation tables, one for each of the data sources.

For each data source, a monthly time-series representation of the data may be developed. For example, the known vehicle sales records may be integrated into a representation providing total monthly sales by vehicle body style, sales state, sales region, etc. Similarly, monthly time series representations of vehicle registrations may be assembled (for all makes, models), as well as monthly time series of sales counts for each vehicle in each sales region.

On a state-by-state basis, a unique model for the inverse of the registration process for each individual state may be computed based on known vehicle sales records and the corresponding known vehicle registration data.

The inverse registration process models may be applied to registration data of competitive vehicles to obtain historical competitive vehicle sales estimates for individual competitive vehicle nameplates, state-region combinations, etc.

More current estimates may be achieved by using the historical estimated sales with the corresponding counts of sampled sales to adaptively adjust an estimate of an amplification factor that should be applied to these sampled transaction counts in order to estimate actual competitive (i.e. unknown) vehicle sales. The estimated amplification factor may be applied to the most recent months of available sampled transaction data to provide “real-time” or more current estimates of competitive vehicle sales. These and other aspects of the present invention are described in greater detail below.

Model of Inverse Registration Process (14)

The following discussion describes preferred algorithms and methodologies for programmatically implementing aspects of the present invention within a computing system. Of course, the algorithms and methodologies may be supplemented or adapted as necessary, within the scope of the present invention, to best-fit a particular implementation scenario.

According to one embodiment, it is assumed that the vehicle registration process for any given state effectively mixes vehicle sales from a number of successive months. For example, a simple model would assert that half of all recorded registrations for a given vehicle in a particular month would have been the result of sales of that vehicle from the current month, while the remaining half of registrations would have been the result of sales from the preceding month. In other words, a time series of vehicle registrations by month can be considered to be the result of a “blurring” of the respective time series of vehicle sales.

It may also be assumed that the registration process for any given state is stationary (i.e., that it does not change over time), and that the pattern of sales within a month are consistent month-to-month (e.g., that weekly sales peaks are consistently observed at month-end). This assumption is not required to practice aspects of the present invention.

A mathematical model of the registration process that estimates registrations for vehicle nameplate v during month t in state s as a function of sales of this vehicle in months t and beforehand can be written as:

$${\hat{R}}_{v , s , t} = {\sum }_{i = 0}^{p} {α}_{s , i} {S}_{v , s , t - i} , \qquad ( 1 )$$

subject to the constraint that

$${α}_{s , i} \geq 0 and {\sum }_{i = 0}^{p} {α}_{s , i} = 1 , \qquad ( 2 )$$

where R_{v,s,t} and S_{v,s,t} are the registration and sales volumes for vehicle v in state s during month t, respectively, \hat{R}_{v,s,t} are the corresponding estimated registration volumes, α_{s,i} are parameters to be estimated, which are unique for each state, but are not vehicle specific, and p is selected to span the maximum number of months required for a new vehicle to be registered. We also impose the constraint on the parameters so that the integrated registration volume is equal to the integrated estimated sales volume.

This model of the registration process does not provide a view of how to estimate sales given registrations. Modeling the inverse of the registration process can be expressed in an autoregressive fashion as:

$${\hat{S}}_{v , s , t} = {\sum }_{i = - {a}_{1}}^{{a}_{2}} {β}_{s , i} {R}_{v , s , t + i} + {\sum }_{j = 1}^{b} {γ}_{s , j} {S}_{v , s , t - j} , \qquad ( 3 )$$

where the parameters are constrained by:

$${\sum }_{i = - {a}_{1}}^{{a}_{2}} {β}_{s , i} + {\sum }_{j = 1}^{b} {γ}_{s , j} = 1. \qquad ( 4 )$$

We can convert this constrained estimation to one that is unconstrained by expressing one of the parameters as a function of the remaining parameters. For example, we may choose to express β_{s,0} as:

$${β}_{s , 0} = 1 - {\sum }_{i = - {a}_{1} , i \neq 0}^{{a}_{2}} {β}_{s , i} - {\sum }_{j = 1}^{b} {γ}_{s , j} . \qquad ( 5 )$$

We rewrite the expression for estimated sales as:

$${\hat{S}}_{v , s , t} = {R}_{v , s , t} + {\sum }_{i = - {a}_{1} , i \neq 0}^{{a}_{2}} {β}_{s , i} ( {R}_{v , s , t + i} - {R}_{v , s , t} ) + {\sum }_{j = 1}^{b} {γ}_{s , j} ( {S}_{v , s , t - j} - {R}_{v , s , t} ) . \qquad ( 6 )$$

Now, we are faced with an unconstrained parameter estimation problem, where we would like to find values for the parameters β_{s,i} and γ_{s,j} that will minimize some appropriate cost function, chosen here to be the sum of squared errors:

$${min}_{v , t} {( {S}_{v , s , t} - {\hat{S}}_{v , s , t} )}^{2} . \qquad ( 7 )$$

This implies a separate estimation situation for each unique state.

The parameters are constrained so that the integrated estimated sales volumes are equal to the integrated registration volumes. However, the actual integrated sales and registration volumes for a particular vehicle in a given state may not be not equal to one another. One method for handling this difference is to assign a weighting factor that provides heavier emphasis in parameter estimation for those vehicles whose integrated volumes are close to one another, and lower emphasis for those vehicles whose integrated volumes are substantially different from one another.

For example, a weight of 1 may be assigned when the volumes are exactly equal, a weight of zero when they differ from one another by more than 10%; one can then perform a linear interpolation between these two extremes.

As formulated above, one can apply the principles of least squares optimization to infer the parameter values. An adaptive scheme may be implemented to allow for the parameter values β_{s,i,t} and γ_{s,j,t} to vary with time:

$$\begin{matrix}\begin{matrix}{\hat{y}}_{v , s , t} = {\hat{S}}_{v , s , t} - {R}_{v , s , t} \\ = {\sum }_{i = - {a}_{1} , i \neq 0}^{{a}_{2}} {β}_{s , i , t} ( {R}_{v , s , t + i} - {R}_{v , s , t} ) + {\sum }_{j = 1}^{b} {γ}_{s , j , t} ( {S}_{v , s , t - j} - {R}_{v , s , t} ) ,\end{matrix} \\ with & ( 8 ) \\ {β}_{s , 0 , t} = 1 - {\sum }_{i = - {a}_{1} , i \neq 0}^{{a}_{2}} {β}_{s , i , t} - {\sum }_{j = 1}^{b} {γ}_{s , j , t} , & ( 9 )\end{matrix}$$

where we now have unique values for the parameters β_{s,i,t} and γ_{s,j,t} for all points in time.

Although variation in the registration process may exist over time, the variation will typically be small and parameter values will typically vary smoothly over time. In other words, the values of the parameters at time t+1 should be related or derived from the values of these same parameters from the previous time t. This may be realized by utilizing an exponentially-weighted recursive least squares parameter estimation algorithm to infer parameter estimates for all points in time.

For example, assume that we have a total of Nᵥ known vehicle nameplates that have been sold and registered in some arbitrary state s, and that we also have corresponding time series of both sales and registration volumes for each of these Nᵥ vehicles. In addition, assume that we have calculated a unique weighting factor μ_{v,s} for each of these vehicles that determines the degree to which any one vehicle should affect the estimation of parameters. Let the index t=1 refer to the first month for which both registration and sales volumes data are available. For the sake of compactness, we will arrange all of the independent variables from the right-hand side of equation (8) into a single vector x_{v,s,t}:

$${x}_{v , s , t} = [ \begin{matrix}{R}_{v , s , t - {a}_{1}} - {R}_{v , s , t} \\ {R}_{v , s , t - {a}_{1} + 1} - {R}_{v , s , t} \\ ⋮ \\ {R}_{v , s , t - 1} - {R}_{v , s , t} \\ {R}_{v , s , t + 1} - {R}_{v , s , t} \\ ⋮ \\ {R}_{v , s , t + {a}_{2}} - {R}_{v , s , t} \\ {S}_{v , s , t - 1} - {R}_{v , s , t} \\ ⋮ \\ {S}_{v , s , t - b} - {R}_{v , s , t}\end{matrix} ] . \qquad ( 10 )$$

Similarly, we arrange the parameters β_{s,i,t} and γ_{s,j,t} into a single vector w_{s,t}, where we note that the parameters are time-specific, but vehicle-independent:

$${w}_{s , t} = [ \begin{matrix}{β}_{s , t} \\ {γ}_{s , t}\end{matrix} ] , \qquad ( 11 )$$

where β_{s,t} and γ_{s,t} are vectors composed of the individuals parameter values in Equation (8).

We also specify an exponential weighting or forgetting factor, λ, that influences the degree to which the most recent information is emphasized relative to older information; note that this is in addition to the weighting factor that we have specified for each vehicle's time series. For example, a forgetting factor of λ=0.825 would give a weight to the observations from 12 months ago that is only 10% (0.825¹²≈0.10) of the weight given to the current set of observations. A forgetting factor of λ=1 would imply uniform weighting over all time.

The exponentially weighted recursive least squares routine may be structured as follows. We initialize the parameter vector w_{s,0} to those values of the parameters β_{s,i}, and γ_{s,j} that are inferred from a straightforward application of least squares estimation to all observations of all vehicles over all time using Equation (6). We also initialize an error covariance matrix P_{s,0}=1/εI, where ε is some small number on order of 0.001. P_{s,0} is a square matrix having a size equal to the number of parameters to be estimated.

One methodology for performing parameter estimation (described below) is an exponentially weighted recursive least squares methodology. Other methodologies including steepest descent and exponential averaging may also be used.

For any given state s, we have two loops over which we perform the parameter estimation. The outer-most loop indexes time, while the inner loop cycles over all N_{υ} vehicles. At the beginning of a new time interval L, we perform the assignments described in equations 12 through 21. In accordance with a preferred embodiment of the present invention, equations 12 and 13 are initialization assignments, and equations 14 through 21 are executed recursively for each vehicle.
ω_{0,s,t}=w_{s,t-1}, (12)
Φ_{0,s,t}=P_{s,t-1}. (13)
ŷ_{υ,s,t}=ω-1,s,t^{T}x_{υ,s,t}. (14)
ξ_{υ,s,t}=\sqrt{μ_{υ,s}}(S_{υ,s,t}−R_{υ,s,t}−ŷ_{υ,s,t}), (15)
h_{υ,s,t}=\sqrt{μ_{υ,s}}x_{υ,s,t}, (16)
b_{υ,s,t}=Φ_{υ-1,s,t}h_{υ,s,t}, (17)
a_{υ,s,t}γ[λ^{1/N}^{_{υ}}V_{s,max}+h_{υ,s,t}^{T}b_{υ,s,t}]⁻¹, (18)
k_{υ,s,t}=b_{υ,s,t}a_{υ,s,t} (19)
ω_{υ,s,t}=ω_{υ-1,s,t}+k_{υ,s,t}ξ_{υ,s,t} (20)
Φ_{υ,s,t}=Φ_{υ-1,s,t}−k_{υ,s,t}b_{υ,s,t}^{T} (21)
where V_{s,max} is the largest sales volume observed at any point in time for any individual vehicle nameplate in state s. Once all N_{υ} vehicles for time t have been processed using these equations, we make the following assignments:

$$\begin{matrix}{w}_{s , t} = {ω}_{{N}_{υ} , s , t} & ( 22 ) \\ {P}_{s , t} = \frac{1}{λ} {Φ}_{{N}_{υ} , s , t} & ( 23 )\end{matrix}$$

Next, the following time interval of data is processed. The parameter values w_{s,t} may be written to a file or memory for future use in developing vehicle sales estimates, as described below.
Application to Competitive Vehicle Sales Estimation (16)

In accordance with a preferred embodiment of the present invention, vehicle sales estimates may be generated on a regional basis, where the regions may span a number of states, and where individual states may be partitioned among different sales regions. In the case where an individual state is covered by multiple sales regions, that state's sales and registrations may be broken up into the components that correspond to the different sales regions. (Note that this distinction was not necessary for developing the inverse registration process models, since, according to the embodiment described, those were exclusively based on data for individual states.)

An additional difference between the parameter estimation scheme and the application to estimating competitive vehicle sales is that actual competitive vehicle sales data is not observed. Accordingly, equation (8) may be modified to use time-lagged estimated sales volumes, rather than time-lagged actual sales volumes, as explanatory variables. We also introduce the subscript r to denote sales for state s in region r:

$$\begin{matrix}{\hat{y}}_{υ , r , s , t} = {\hat{S}}_{υ , R , S , T} - {R}_{υ , r , s , t} \\ = {\sum }_{i = - {a}_{1} , i \neq 0}^{{a}_{2}} {β}_{s , i , t} ( {R}_{υ , r , s , t + i} - {R}_{υ , r , s , t} ) + \\ {\sum }_{j = 1}^{b} {γ}_{s , j , t} ( {\hat{S}}_{υ , r , s , t = j} - {R}_{υ , r , s , t} ) ,\end{matrix} \qquad ( 24 )$$

where we now assume that the monthly registration volumes R_{υ,r,s,t} correspond to a competitive vehicle nameplate of a given model year which are sold within a particular region- state combination (subscripts r, s).

Note that sales are estimated at the combined region-state level, of which there are more combinations than either the number of states or the number of regions. To estimate the total number of sales of the nameplate-model year vehicle υ in region r involves the summation over the estimated sales in those parts of the states that overlap region r. This is most conveniently expressed as:

$${\hat{S}}_{υ , r , * , t} = {\sum }_{s = 1}^{50} {\hat{S}}_{υ , r , s , t} , \qquad ( 25 )$$

where Ŝ_{υ,r,s,t}=0 if region r does not encompass at least a part of state s, and where we have used the subscript * to denote sales estimates over all possible states. Similarly, the national sales of this same vehicle would be given by:

$${\hat{S}}_{υ , * , * , t} = {\sum }_{r = 1}^{{N}_{r}} {\hat{S}}_{υ , r , * , t} . \qquad ( 26 )$$

where Nᵣ is the number of sales regions. A variety of other useful sales estimates may be implemented. For example, vehicle sales may be computed independent of model year. Alternatively, brand specific volumes may be computed at a variety of levels of aggregation, and a national model can be created which ignores state and regional detail. An unlimited variety of estimates at varying levels of detail may be generated.
Real-Time Estimates (18)

As discussed above, the estimation of sales volumes using registration data may be lagged. For example, registrations that occur in the month of September may be gathered and processed during the month of October and made available to the public early in the month of November. However, the best we can typically expect is to be able to estimate sales up through the month of August, given that estimated sales require a forward view of registrations (since sales in August will typically result in September registrations). However, it is desirable to have estimates of competitive vehicle retail sales closer to the time they occur.

Typically, the automotive market data sources sample sales transaction data from a subset of dealerships for a variety of vehicle makes and models. This data provides a real-time view of the sampled sales, but does not by itself provide an absolute view of actual sales, since the sampling process is not uniform. However, we can use an adaptive filter algorithm to map the known sampled sales counts to estimates of actual vehicle sales by exploiting the estimates derived from registration data.

A unique sequence of amplification factors may be developed for each unique nameplate (independent of model year) in each sales region.

Let U_{υ,r,t} denote the known sampled sales count of vehicles of type v sold in region r for month t. We also have from above an estimate of total regional sales for that same vehicle, given by Ŝ_{υ,r,*,t}, where * indicates that the estimated sales have been integrated over all states for region r. Assume a model of the form
Ŝ_{υ,r,*,t}′=ρ_{υ,r,t-1}U_{υ,r,t}, (28)

The estimation scheme for this model may be defined according to equations 28 through 34, and implemented in a recursive fashion over time.

$$\begin{matrix}{ξ}_{υ , r , t} = {\hat{S}}_{υ , r , * , t} - {\hat{S}}_{υ , r , * , t}^{′} , & ( 29 ) \\ {b}_{υ , r , t} = {p}_{υ , r , t - 1} {U}_{υ , r , t} , & ( 30 ) \\ {a}_{υ , r , t} = {[ λ + {U}_{υ , r , t} {b}_{υ , r , t} ]}^{- 1} , & ( 31 ) \\ {k}_{υ , r , t} = {b}_{υ , r , t} {a}_{υ , r , t} , & ( 32 ) \\ {ρ}_{υ , r , t} = {ρ}_{υ , r , t - 1} + {k}_{υ , r , t} {ξ}_{υ , r , t} , & ( 33 ) \\ {p}_{υ , r , t} = \frac{1}{λ} [ {p}_{υ , r , t - 1} - {k}_{υ , r , t} {b}_{υ , r , t} ] . & ( 34 )\end{matrix}$$

Note that this estimation scheme produces a series of time-varying parameter estimates that are both vehicle and region specific, while the scheme for modeling the registration processes produced a series of time-varying parameter estimates that were state-specific (in other words, these latter parameter estimates could be applied to vehicles of any make or model). Estimates may also be created by brand, at the national level.

Assume that the last month for which we had previously estimated sales using registration data is denoted by t_{f}, and that we have sampled sales data for a number of months following month t_{f}. Then, we would simply apply the amplification factor as inferred for month t_{f} to the sampled sales time series for the following months to obtain real-time estimates:
Ŝ_{υ,r,*,t}_{_{f}}₊ₖ=ρ_{υ,r,t}_{_{f}}U_{υ,r,t}_{_{f}}₊ₖ, (35)
where k is some number of months after we last estimated sales volumes using registration data.
System Implementation

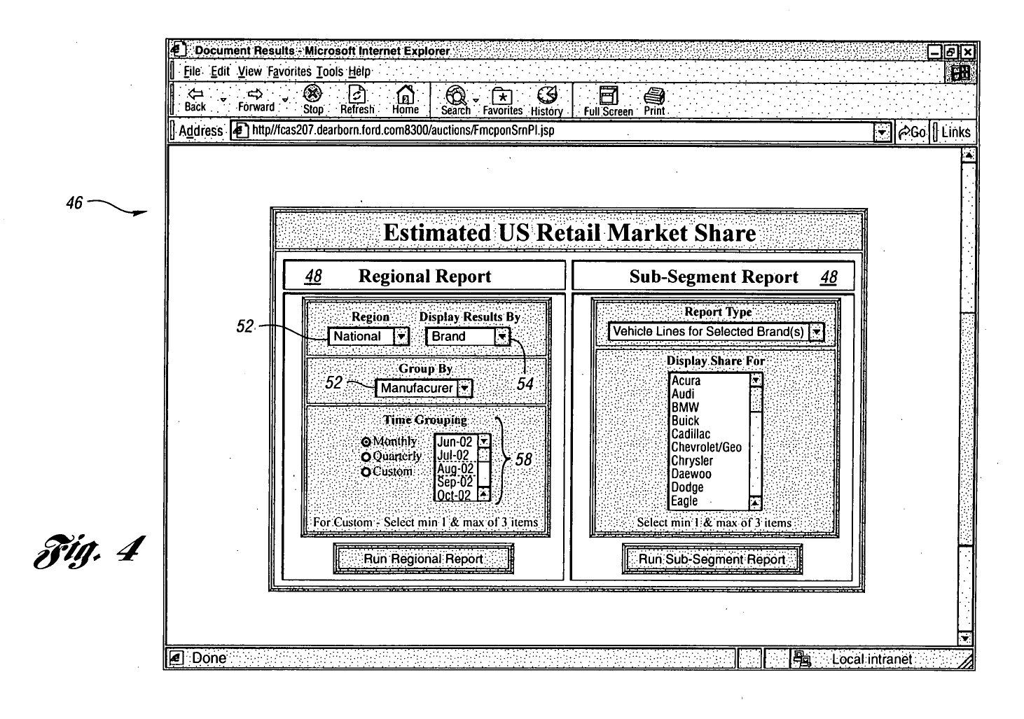

FIG. 3 is a network architecture diagram illustrating a preferred computing system for implementing an embodiment of the present invention. Computer server 34 receives known vehicle sales data 36, registration data 38, and sampled vehicle sales volume data 40 for processing as described in greater detail above. As described in greater detail below, web server 42 is in operable communication with computer server 34, and enables users 44 to query processed data in a variety of useful ways (discussed in greater detail above and below).

In accordance with a preferred embodiment of the present invention, application software for implementing data processing, data storage, and data output in the system implementation may be written using PERL. During routine operation, flat data files are received via FTP at server 34 and include known vehicle sales data 36, vehicle registration data 38, and sampled sales data 40. Preferably, these files are received/updated and processed on a weekly basis or more frequently. Server 34 processes the data and outputs original/processed data to one or more databases 43.

Web server 42 may include application software enabling users 44 to query database 43 to create market share reports (discussed in greater detail below).

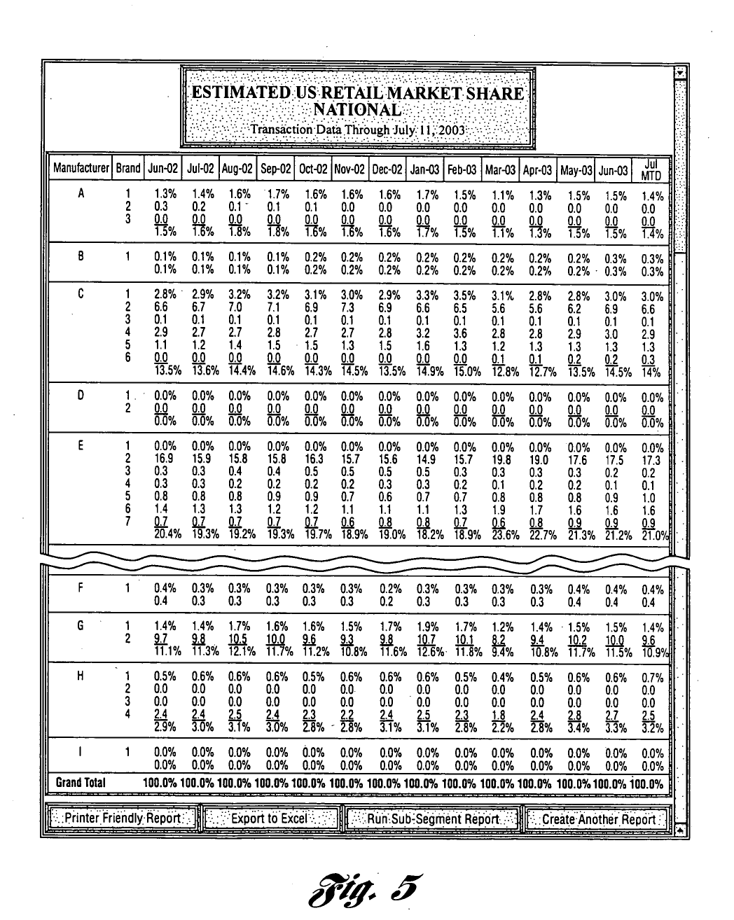

FIG. 4 is an example of graphical user interface (GUI) 46 for querying processed data in accordance with one aspect of the present invention. Utilizing GUI 46, users can observe estimates of historical retail vehicle sales across the competitive marketplace based on certain known vehicle sales data, vehicle registration data, and sampled sales data as discussed in greater detail above. GUI 46 includes functionality 48 and 50 for generating a regional report and/or a sub-segment report, respectively.

Regional reports may display a time series of market share estimates (share of sales in a specific region). Share estimates can be done at the name plate brand level, the manufacturer level, a sub-segment level, or a super-segment level. To specify parameters for a regional report, a user selects a region 52, a display format 54, a matter to group to share estimates 56, and a time grouping 58.

With respect to time groupings 58, reports can be generated with monthly shares (current MTD and 13 prior months), quarterly shares (current QTD and 3 prior quarters) or custom. Selecting a custom time grouping requires additionally selecting a period end point.

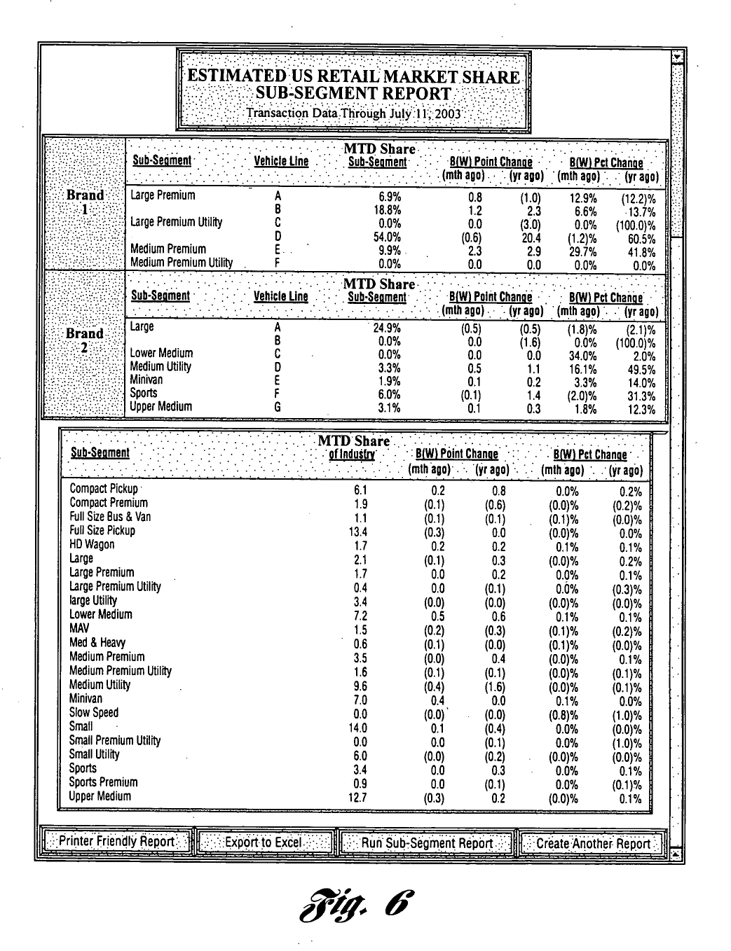

FIG. 5 is an example national U.S. retail market share report generated in accordance with one aspect of the present invention. The report sets forth, for a plurality of manufacturers 60 and manufacturer brands 62, U.S. retail market share data 64 for a given date range (e.g. through Jul. 11, 2003). The time period for the example report shown in FIG. 5 is monthly.

Buttons 66 enable a user to create a print-friendly version of the report, export the report data to EXCEL, run a sub-segment report, and create another report. By selecting the sub-segment report button, a sub-segment report will be created based on selections made in the sub-segment report setup box 50 shown in FIG. 4. If the user has not submitted any sub-segment report parameters, a report may be generated using default settings.

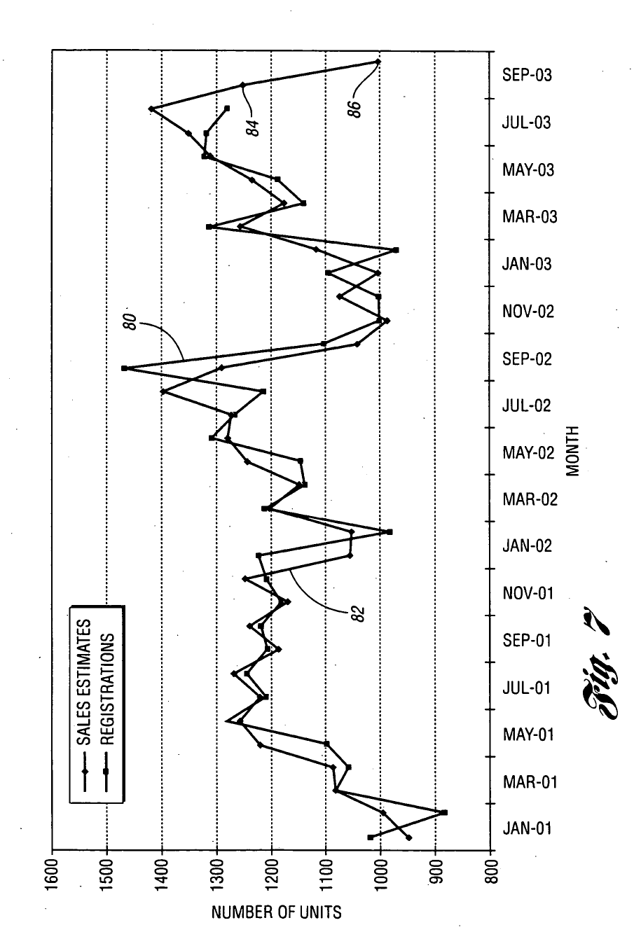

FIG. 6 is an example U.S. retail market share sub-segment report generated in accordance with one aspect of the present invention. This sub-segment report is presented in a share-by-brand format with Brands 1 and 2 selected in sub-segment report GUI 50 shown in FIG. 4. For each selected brand 68 and 70, a corresponding month-to-date share report is provided 72 and 74, respectively.

In addition to showing the current month-to-date share of a sub-segment, the report also shows a better (worse) than the prior month value, and a year on both a percentage point and a percentage change bases. Region 76 displays the sub-segment's share of the national light vehicle industry. This aspect of the report provides the user with a perspective of relative segment size and growth or contraction.

FIG. 7 is a chart displaying an example comparison between known vehicle registration data and corresponding sales estimates generated in accordance with embodiments of the present invention. Known retail vehicle registration data 80 is plotted for a particular vehicle in a particular geographic region, from January 2001 to October 2003. Using aspects of the present invention described above, corresponding sales estimates 82 are provided. As expected, vehicle registrations typically occur shortly after the estimated sales occurred. Notably, vehicle sales estimates 84 and 86 are provided for the months of September 2003 and October 2003, even though no vehicle registration data 80 is available. As described in greater detail above, these estimates may be derived by combining the registration-based sales estimates with sampled sales transactions data for the months of September 2003 and October 2003. This method can also be extended to estimate vehicle sales for the most recent time period (e.g., the most recent week of sales).

While the best mode for carrying out the invention has been described in detail, those familiar with the art to which this invention relates will recognize various alternative designs and embodiments for practicing the invention as defined by the following claims.

1. A computer-implemented method for estimating vehicle sales, the method comprising:
receiving data representing known vehicle sales into a computing system;
receiving data representing vehicle registrations corresponding to the known vehicle sales into the computing system;
processing the data representing known vehicle sales and the data representing vehicle registrations corresponding to the known vehicle sales within the computing system to create a model of vehicle sales as a function of vehicle registrations; and
within the computing system, applying the model to registration data for vehicles having unknown sales information to compute a vehicle sales estimate for the vehicles having unknown sales information.

2. The method of claim 1 additionally comprising computing an estimate of near real-time competitive vehicle sales based on a set of sampled sales transaction data and the vehicle sales estimate.

3. The method of claim 1 additionally comprising adapting the model based on a set of known vehicle sales transactions to compute vehicle sales estimates for vehicles having unknown sales information and unknown registration information.

4. The method of claim 3 wherein an adaptive filter algorithm is implemented to adapt the model.

5. The method of claim 1 wherein the known vehicle sales information includes a date of sale.

6. The method of claim 1 wherein the processing step includes translating vehicle body style descriptions into a common set of definitions and developing a monthly time-series representation of known vehicle sales and corresponding registration data.

7. The method of claim 1 wherein the model is created on a regional basis.

8. The method of claim 1 wherein the model is created on for one or more vehicle brands.

9. The method of claim 1 wherein a plurality of models are created.

10. The method of claim 1 additionally comprising generating one or more regional reports including a plurality of sales estimations for a plurality of brands over a period of time.

11. The method of claim 1 additionally comprising generating one or more sub-segment reports including a plurality of sales estimations for one or more brands over a period of time.

12. A computer system for estimating vehicle sales, the system comprising one or more computers operably programmed and configured to:
receive data representing known vehicle sales information;
receive data representing vehicle registrations corresponding to the known vehicle sales;
process the known vehicle sales information and the corresponding vehicle registration data to create a model of vehicle sales as a function of vehicle registrations; and
apply the model to registration data for vehicles having unknown sales information to compute a sales estimate for the vehicles having unknown sales information.

13. The system of claim 12 wherein the one or more computers are additionally programmed and configured to compute an estimate of near real-time competitive vehicle sales based on a set of sampled sales transaction data and the vehicle sales estimate.

14. The system of claim 12 wherein the one or more computers are additionally programmed and configured to adapt the model based on a set of known sampled vehicle sales transactions to compute vehicle sales estimates for vehicles having unknown sales information and unknown registration information.

15. The system of claim 14 wherein an adaptive filter is implemented to adapt the model.

16. The system of claim 12 wherein the processing includes translating vehicle body style descriptions into a common set of definitions and developing a monthly time-series representation of the known new vehicle sales and corresponding registration data.

17. The system of claim 12 wherein the model is created on a regional basis.

18. The system of claim 12 wherein the model is created for one or more vehicle brands.

19. The system of claim 12 wherein a plurality of models are created.

20. The system of claim 12 wherein the one or more computers are additionally programmed and configured to generate one or more regional reports that include a plurality of sales estimations for a plurality of vehicle brands over a period of time.

21. The system of claim 12 wherein the one or more computers are additionally programmed and configured to generate one or more sub-segment reports that include a plurality of sales estimations for one or more vehicle brands over a period of time.

22. The system of claim 12 wherein the system is implemented on a web-based platform.

23. A computer-implemented method for estimating unknown new vehicle sales, the method comprising:
(i) a step for receiving available vehicle sales and vehicle registration data corresponding to those vehicles sold;
(ii) a processing step for generating an inverse model of registration processes based on the data collected in step (i); and
(iii) a step for applying the model to vehicle registration data for vehicles having unavailable sales information to compute a sales estimate for those vehicles.

24. The method of claim 23 additionally comprising a step for adapting the model to calculate vehicle sales estimates for vehicles having unavailable sales information and unavailable registration information.

25. The method of claim 23 additionally comprising a step for computing an estimate of near real-time competitive vehicle sales.
